(19) United States
(12) Patent Application Publication
(10) Pub. No.: US 2011/0228322 A1
(43) Pub. Date: Sep. 22, 2011

(54) MAP INFORMATION PROCESSING APPARATUS AND MAP INFORMATION PROCESSING PROGRAM

(75) Inventors: Taira Ashikawa, Shizuoka (JP); Shigeo Uchida, Shizuoka (JP); Satoshi Oyama, Shizuoka (JP); Katsuhito Mochizuki, Shizuoka (JP)

(73) Assignee: TOSHIBA TEC KABUSHIKI KAISHA, Tokyo (JP)

(21) Appl. No.: 13/032,730

(22) Filed: Feb. 23, 2011

(30) Foreign Application Priority Data
Mar. 18, 2010 (JP) 2010-063079

(51) Int. Cl. G06K 15/02

(52) U.S. Cl. 358/1.15

(57) ABSTRACT

According to one embodiment, a map information processing apparatus includes a generation unit, a transmitter, a receiver, an extraction unit, a determination unit, and a registration unit. The generation unit is configured to generate a print image for printing a map designated by a user. The transmitter is configured to transmit to a print device the print image. The receiver is configured to receive an image transmitted from the print device. The extraction unit is configured to extract a differential image by extracting a difference between the image and the print image. The determination unit is configured to determine registration information which is a target of registration, based on the differential image and the map corresponding to the print image. The registration unit is configured to register the registration information in an information registration device.

### CROSS-REFERENCE TO RELATED APPLICATIONS

This application is based upon and claims the benefit of priority from Japanese Patent Application No. 2010-063079, filed Mar. 18, 2010; the entire contents of which are incorporated herein by reference.

### FIELD

Embodiments described herein relate generally to a map information processing apparatus and a map information processing program.

### BACKGROUND

In recent years, a ubiquitous environment, which enables access to digital information at any place at any time, has been in development. Thereby, it has been able to refer to map information by accessing a Web service, which provides map information, from a browser, such as mobile phone, at a travel destination.

On the other hand, when a map is displayed on a portable digital device such as a mobile phone, the screen is small and the visibility is poor in the case of complex map information or small-scale map information (a reduction-scale denominator is large). Thus, many people print out map information on paper, and carry a paper medium.

There is known a Web service by which a user registers information and can share the information with acquaintances. In the prior art, when a user tries to register on the Web service the information which is designated by the user in connection with the map information, for instance, the information on routes of passage by the user or comments, a great deal of labor is needed if the user carries a paper medium. For example, when the user has written information on a paper medium, it is necessary for the user to first digitize the information and then to register the digitized information. In particular, when the user carries the map information on a plurality of paper media, it is difficult to mutually associate information pieces written on the plural paper media.

### BRIEF DESCRIPTION OF THE DRAWINGS

FIG. 1 is an exemplary view illustrating the entire structure of a map information processing system in an embodiment.

FIG. 2 is an exemplary block diagram illustrating the functions of the map information processing system in the embodiment.

FIG. 3 is an exemplary flow chart illustrating a print process by a map print module of a map information processing apparatus in the embodiment.

FIG. 4 is an exemplary view illustrating an example of an initial screen for print setup in the embodiment.

FIG. 5 is an exemplary view illustrating an example of a print image in which a single map image in the embodiment is combined with a QR code representing an identification code image.

FIG. 6 is an exemplary view illustrating an example of a print map information storage table in which print map information is recorded by a print image generation unit in the embodiment.

FIG. 7 is an exemplary view illustrating an example of a plurality of maps printed by an MFP in the embodiment.

FIG. 8 is an exemplary view illustrating an example of a differential image in the embodiment.

FIG. 9 is an exemplary flow chart illustrating a scan process of a map information registration module in the embodiment.

FIG. 10 is an exemplary flow chart illustrating an example of a determination method of determining information that is to be registered, by a registration information determination unit in the embodiment.

FIG. 11 is an exemplary flow chart illustrating an example of the determination method of determining information that is to be registered, by the registration information determination unit in the embodiment.

FIG. 12 is an exemplary flow chart illustrating an example of the determination method of determining information that is to be registered, by the registration information determination unit in the embodiment.

### DETAILED DESCRIPTION

In general, according to one embodiment, a map information processing apparatus comprises a generation unit, a transmitter, a receiver, an extraction unit, a determination unit, and a registration unit. The generation unit is configured to generate a print image for printing a map designated by a user. The transmitter is configured to transmit to a print device the print image generated by the generation unit. The receiver is configured to receive an image transmitted from the print device. The extraction unit is configured to extract a differential image by extracting a difference between the image received by the receiver and the print image. The determination unit is configured to determine registration information which is a target of registration, based on the differential image and the map corresponding to the print image. The registration unit is configured to register the registration information, which is determined by the determination unit, in an information registration device.

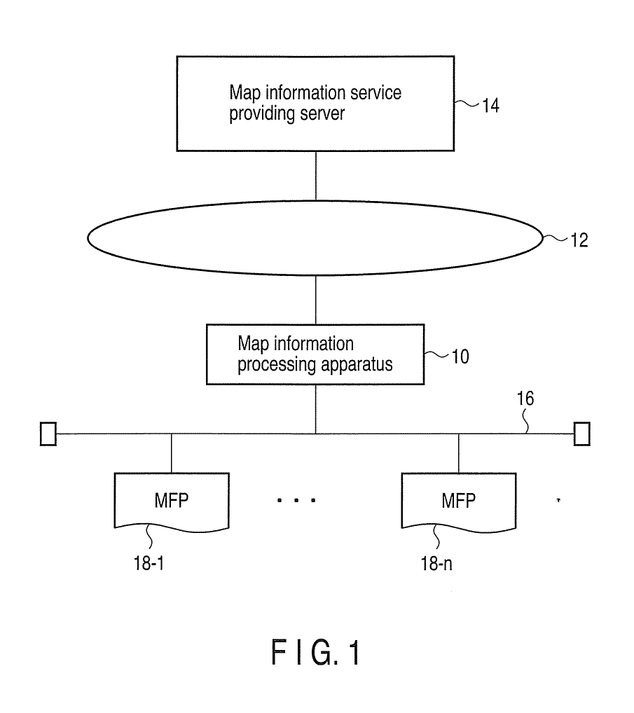

FIG. 1 is an exemplary view illustrating the entire structure of a map information processing system in an embodiment. The map information processing system includes a map information processing apparatus 10, a map information service providing server 14 which is connected via the Internet 12, and a plurality of MFPs (Multi-Function Printers) 18 (18-1, . . . , 18-n) which are connected to the map information processing apparatus 10 via a LAN (Local Area Network) 16.

The MFP 18 is a multi-function peripheral having, for example, a printer function, a scanner function and a copy function. The MFP 18 is connected to the Internet 12 via the LAN 16, and can access, for example, the map information service providing server 14 and can transmit/receive data.

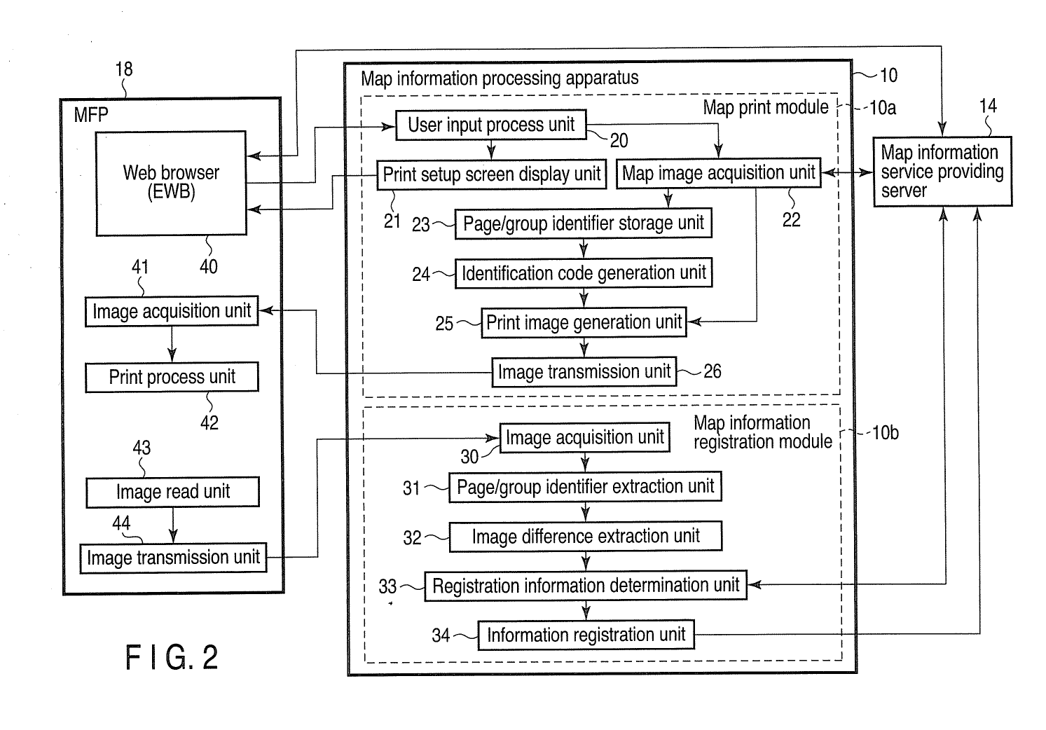

FIG. 2 is an exemplary block diagram illustrating the functions of the map information processing system in the embodiment.

As shown in FIG. 2, the function of a computer is implemented in the MFP 18. The MFP 18 executes various programs by a processor, thereby realizing an embedded Web browser (EMB) 40 which is used at a time of accessing information which is provided by a Web site opened to the public on the Internet 12 or from the map information processing apparatus 10; an image acquisition unit 41 which acquires map information including a map image from the map information processing apparatus 10 or map information service providing server 14; a print process unit 42 which prints an image, which is acquired by the image acquisition unit 41, on a paper medium according to print setup designated by a user; an image read unit 43 which scans an original (e.g. a paper medium on which a map is printed) that is set on the MFP 18, and reads an image of the original; and an image transmission unit 44 which transmits the image, which has been read by the image read unit 43, to a location (map information processing apparatus 10) designated by the user.

The map information processing apparatus 10 provides a server function which is realized by a computer. The map information processing apparatus 10 executes a program, which is recorded in a recording medium such as a memory, by a processor, thereby realizing various functions. The map information processing apparatus 10 executes a map information processing program, thus being able to provide processing functions by a map print module 10a which executes a process for printing a map according to a user's designation in the MFP 18, and by a map information registration module 10b which executes a process for extracting information relating to map information, which is input by the user, from the image read by the MFP 18 and registering the extracted information in the map information service providing server 14.

The map print module 10a includes a user input process unit 20 which receives an access request from the user or designated information (map information, the number of prints, a print instruction, etc.) via the Web browser 40 of the MFP 18 and determines the next process; a print setup screen display unit 21 which displays a setup screen, which designates a map image, the number of prints, a print instruction button, etc., on the Web browser 40 according to the access request received by the user input process unit 20; a map image acquisition unit 22 which acquires a map image from the map information service providing server 14 in accordance with the map information and the number of prints designated by the user; a page/group identifier storage unit 23 which generates identifiers indicating the relationship between a plurality of print images when a plural number of prints has been designated by the user, the page/group identifier storage unit 23 being configured to create an identifier (group identifier) in units of a print instruction by the user, to store the latitude, longitude and reduction scale designated by the user in association with the group identifier, to create an identifier (page identifier) for each map image that is printed, and to store, in a mutually associated manner, the page identifier, the group identifier, the latitude, the longitude, the reduction scale and the map image; an identification code generation unit 24 which generates an identification code image which represents the page identifier; a print image generation unit 25 which generates an image in which the identification code image is superimposed on a designated location of the map image acquired by the map image acquisition unit 22; and an image transmission unit (transmitter) 26 which transmits this image to the MFP 18.

The map information registration module 10b includes an image acquisition unit (receiver) 30 which acquires an image which is transmitted from the image transmission unit 44 of the MFP 18; a page/group identifier extraction unit 31 which extracts the identification code image from the image acquired by the image acquisition unit 30 and extracts the page identifier and group identifier from the identification code image; an image difference extraction unit 32 which extracts a difference between the map image (print image) stored in the map print module 10a in association with the page identifier and the image acquired from the MFP 18 by the image acquisition unit 30; a registration information determination unit 33 which determines information which is to be registered in the map information service providing server 14, based on the difference result and the map information acquired from the map information service providing server 14; and an information registration unit 34 which registers information on the designated service, based on the determination result of the registration information determination unit 33.

In addition, the map information service providing server 14 is a server which provides map information as a Web service. The map information service providing server 14 is accessed by the map information processing apparatus 10 and MFP 18 via the Internet 12. Specifically, if the latitude, longitude and reduction scale (scale) at the center of the map that is the target of access are designated, the map information service providing server 14 returns map information of the designated location. The map information includes information relating to objects printed in the map, such as shops and roads which are set in association with the map image or the location in the map (e.g. the position indicated by the latitude and longitude). The information relating to shops and roads may include, for example, various additional information, in addition to locations.

Next, the operation of the map information processing system in the embodiment is described with reference to flow charts.

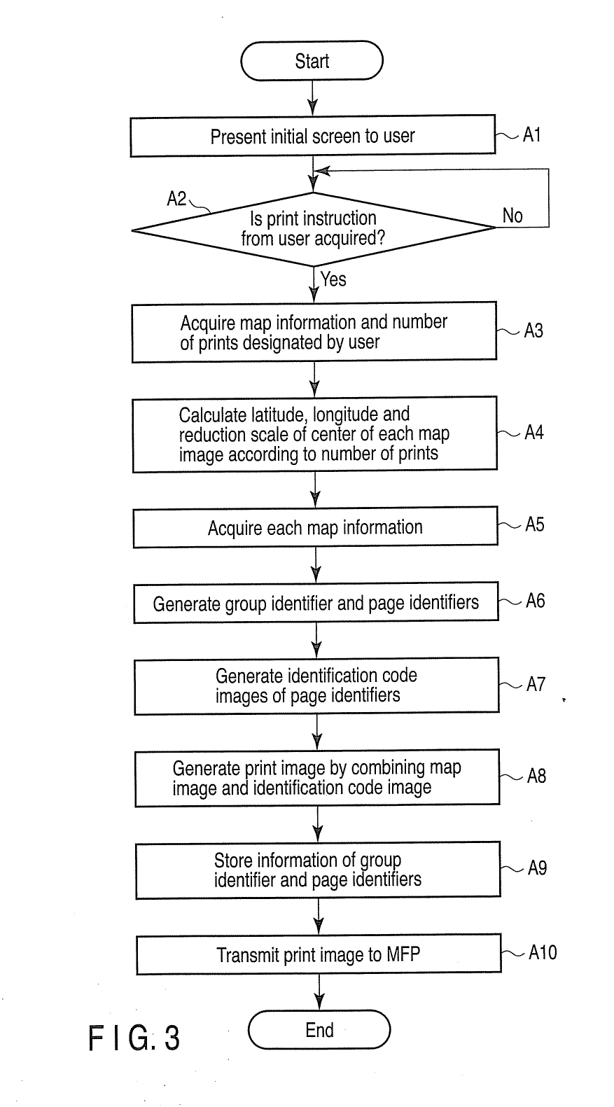

FIG. 3 is an exemplary flow chart illustrating a print process by the map print module 10a of the map information processing system 10.

To start with, if the Web browser 40 (EMB) is started by an instruction from the user, the MFP 18 accesses the map information processing apparatus 10 via the Web browser 40. Responding to the access from the MFP 18, the user input process unit 20 of the map information processing system 10 causes the print setup screen display unit 21 to display the initial screen for print setup on the MFP 18 via the Web browser 40.

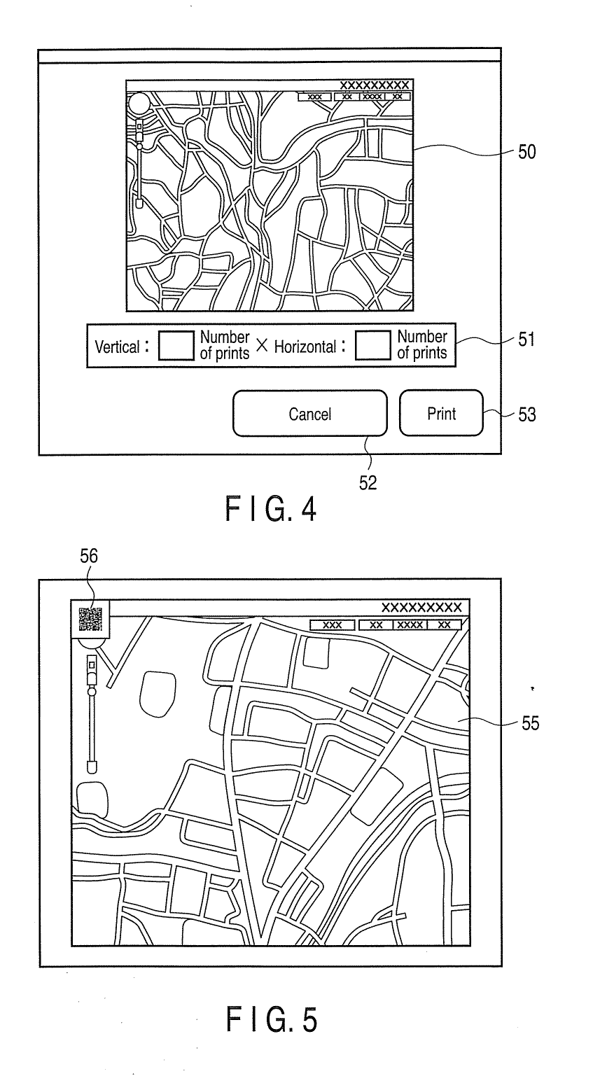

FIG. 4 is an exemplary view illustrating an example of the initial screen for print setup. The print setup screen display unit 21 displays a print setup screen including, for example, a map information display area 50 for displaying map information; a print setup area 51 for setting the number of prints in the vertical direction and the number of prints in the horizontal direction at a time of printing the map displayed in the map information display area 50; a cancel button 52 for instructing cancellation of print setup; and a print execution button 53 for instructing execution of print.

A map image, which is first displayed in the map information display area 50, displays, for example, a location which is uniquely determined by the system. In addition, as regards the numbers of prints in the vertical direction and horizontal direction for the print setup, only preset combinations (e.g. 2×2, 3×3, etc.) may be set to be selectable, with use of a list box.

It is assumed that a script language (e.g. Java script), which request the map information service providing server 14 to display the map of a designated location, is embedded in, e.g. HTML (Hyper Text Markup Language) which defines the display of the map information display area 50. Thereby, the Web browser 40 (EWB) of the MFP 18, which displays the print setup screen, can directly access the map information service providing server 14, can receive map information corresponding to the location (latitude, longitude) and reduction scale which are designated by the user in the map information display area 50, and can display the map.

If the map (location) that is to be printed and the number of prints (the numbers of prints in the vertical and horizontal directions) are designated on the print setup screen by the user who operates the MFP 18 and the print execution button 53 is pressed (Act A2), the user input process unit 20 acquires, through the Web browser 40, the latitude, longitude and reduction scale of the center of the map which is currently displayed in the map information display area 50, and the number of prints, which is set in the print setup area 51 (Act A3).

The map image acquisition unit 22 acquires the information from the MFP 18 via the user input process unit 20, and calculates the latitude, longitude and reduction scale of the central position of each map image at a time when the map (location) that is to be printed is divided according to the number of prints (Act A4).

Subsequently, the map image acquisition unit 22 transmits to the map information service providing server 14 the latitude, longitude and reduction scale of the central position of each map image that is to be printed, and acquires the map information of the corresponding number of prints (Act A5).

An example of the method of calculation of the central position (latitude, longitude) and reduction scale of the map of each map image, which is to be printed, is as follows:

α: the latitude of the central position of the original map,

β: the longitude of the central position of the original map,

Z: the reduction scale of the original map,

R: the distance (m) of the circumference of the Earth,

H: the vertical size (cm) of screen display,

W: the width size (cm) of screen display,

Row: the number of prints in the vertical direction,

Col: the number of prints in the horizontal direction,

CenterHeight (j): the distance in the vertical direction from the central position of the map after division to the central position of the original map,

δ_lat (j): the difference in latitude between the central position of the map after division and the central position of the original map,

θ_lat (j): the latitude of the central position of the map after division,

CenterWeight (i): the distance in the horizontal direction from the central position of the map after division to the central position of the original map,

δ_lng (i): the difference in longitude between the central position of the map after division and the central position of the original map,

θ_lng (i): the longitude of the central position of the map after division,

γ: the reduction scale ratio of the map after division, and

Math.floor (x): an integer obtained by rounding down a decimal fraction of x.

In the above case, the latitude, longitude and reduction scale after division are calculated as follows:

δ_lat(j)=CenterHeight(j)*360/R,

θ_lat(j)=α+δ_lat(j) (the case of j≧0),

θ_lat(j)=α−δ_lat(j) (the case of j<0),

δ_lng(i)=CenterWeight(i)*360/(R*cos(α/180*π),

θ_lng(i)=β+δ_lag(i) (the case of i≧0),

θ_lng(i)=β−δ_lag(i) (the case of i<0),

γ=Z*Row (the case of Row≦Col)

γ=Z*Col (the case of Row>Col)

[Case in which Row is an even number]

j=±1, . . . , ±(Row/2)

CenterLength(j)=(|j|−½)*H/(100*Z*Row)

[Case in which Row is an odd number]

j=0,±1, . . . , ±Math.floor(Row/2)

CenterLength(j)=(|j|*H/(100*Z*Row)

[Case in which Col is an even number]

i=±1, . . . , ±(Col/2)

CenterWidth(i)=(|i|−½)*W/(100*Z*Col)

[Case in which Col is an odd number]

i=0,±1, . . . , ±Math.floor(Col/2)

CenterWidth(i)=|i|*W/(100*Z*Col).

Next, the page/group identifier storage unit 23 of the map information processing apparatus 10 generates identifiers for managing a plurality of map images into which a map (location) to be printed is divided according to the number of prints. In this case, the page/group identifier storage unit 23 generates page identifiers which are allocated to the plural map images that are printed, and a group identifier which is common to the plural map images and is allocated to a unit of a print instruction by the user.

Subsequently, the identification code generation unit 24 generates identification code images representing the page identifiers of the respective map images and the group identifier, which have been generated by the page/group identifier storage unit 23. In this case, it is assumed that a QR (Quick response) code is generated as the identification code image (Act A7). If identification is possible in a scan process that is to be described later, an identification code image of a form, which is other than the QR code, may be generated.

The print image generation unit 25 combines the plural map images with identification code images (RQ codes) corresponding to the respective plural map images, and generates print images corresponding to the number of prints (Act A8). The map information processing apparatus 10 records the print images generated by the print image generation unit 25.

FIG. 5 is an exemplary view illustrating an example of a print image in which a single map image 55 is combined with a QR code 56 representing an identification code image.

In the print image shown in FIG. 5, the QR code 56 is superimposed on an upper left corner of the map image 55. By setting a specific position at which the position of the QR code 56 is to be combined, it becomes possible to reduce the load of the process of extracting the identification code image in the scan process. The position at which the QR code 56 is combined is not limited to the specific position, and may be set at an arbitrary position if the identification code image can be extracted in the scan process.

In addition, the print image generation unit 25 records the group identifier, the latitude and longitude of the central position and the reduction scale, which are designated by the user, in a mutually associated manner, on a print map information storage table for recording print map information relating to printed maps. Further, the print image generation unit 25 records the page identifier, the latitude and longitude of the central position of the map corresponding to the print image, the reduction scale, the group identifier and an image path indicative of the destination of recording of the map image, in a mutually associated manner on the print map information storage table.

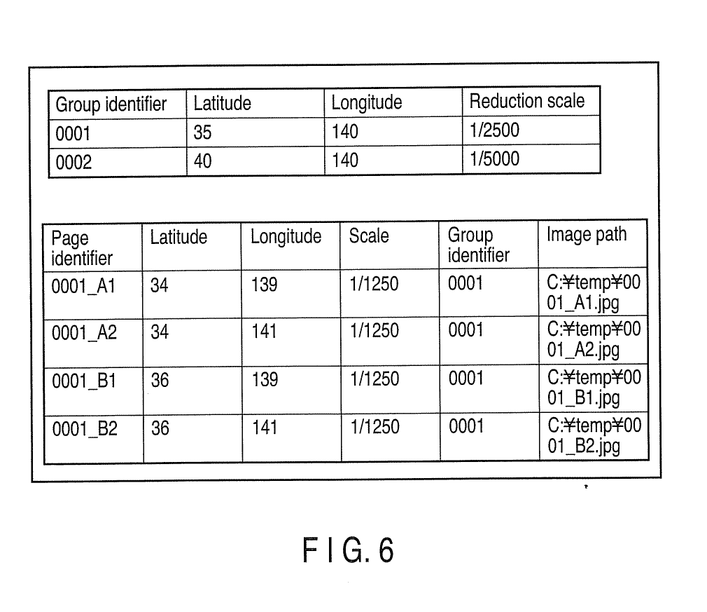

FIG. 6 is an exemplary view illustrating an example of the print map information storage table in which print map information is recorded by the print image generation unit 25.

In the print map information storage table shown in FIG. 6, for example, a print instruction, to which a group identifier “0001” is allocated, indicates that a map with a latitude “35”, a longitude “140” and a reduction scale “1/2500” has been designated as a target of print.

It is also indicated that page identifiers “0001_A1”, “0001_A2”, “0001_B1” and “0001_B2” are allocated to a plurality of print images (in this example, four map images) corresponding to the group identifier “0001”. For example, as regards the print image (map image) corresponding to the page identifier “0001_A1”, it is recorded that the latitude is “34”, the longitude is “139”, the reduction scale is “1/250” and the image path to the destination of recording is “C\temp0001_A1.jpg”. By setting the number of prints to a plural number, the range of the map which can be printed on a single sheet increases. Thus, the scale increases in accordance with the number of prints. In this example, since the original map is divided into four maps comprising two maps in the vertical direction and two maps in the horizontal direction, the reduction scale “1/2500” of the original map is changed to “1/1250”.

Next, the image transmission unit 26 transmits the print images, which correspond to the map designated by the user, to the MFP 18 which has executed access from the Web browser 40 (Act A10). In the case where the user designated a plural number of prints on the print setup screen, the image transmission unit 26 transmits the print images corresponding to the plural number of prints, which have been generated by the print image generation unit 25, as described above.

The method of transmission of print images between the map information processing apparatus 10 (image transmission unit 26) and the MFP 18 is as follows. A print driver is pre-installed in the map information processing apparatus 10. Images are transmitted to the MFP 18 via the printer driver corresponding to the MFP 18 which has accessed to the map information processing apparatus 10 via the Web (Internet 12). Alternatively, without installing the print driver in the map information processing apparatus 10, print images may be transmitted by using a Web service such as Devices Profile for Web Services (DPWS).

Besides, in the MFP 18, the content of print setup at a time of printing map images may be instructed. In this case, for example, such configuration is adopted that the print setup, as well as the setup relating to the map (the map and the number of prints), can be executed by the user on the print setup screen. In the print setup, for example, such configuration is adopted that the number of prints, color print (color mode), monochrome print, and the number of maps printed on one sheet can arbitrarily be designated by the user. The image transmission unit 26 transmits print images to the MFP 18 in a format in which print images are combined with a print instruction describing the print setup, for example, in XPS (XML Paper Specification) format.

On the other hand, if the image acquisition unit 41 of the MFP 18 receives a print image from the map information processing apparatus 10, the image acquisition unit 41 delivers the print image to the print process unit 42. The print process unit 42 executes printing, based on the print image, by the printer function. When the print instruction describing the print setup has been received, the print corresponding to the description of the print instruction is executed. When a plurality of print images have been received, a plurality of maps are printed.

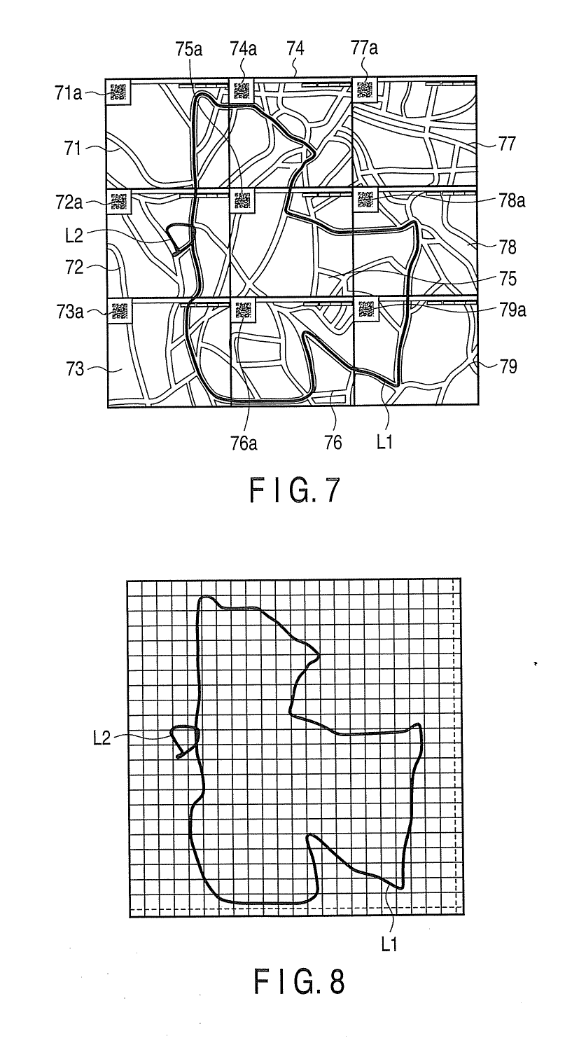

FIG. 7 is an exemplary view illustrating an example of a plurality of maps printed by the MFP 18.

The example shown in FIG. 7 shows the case in which the number of prints of a map, which is to be printed by the user, is set at 9 (three maps in the vertical direction and three maps in the horizontal direction). Nine maps 71 to 79 are combined with QR codes 71a to 79a representing page identifiers corresponding to the nine maps 71 to 79 at preset positions (upper left corners) of the nine maps 71 to 79.

Since the map, which has been designated as a target of print, is divided into nine maps and printed, the scale of the map that is printed on a single sheet is increased. The user can possess the map of a necessary range by dividing the map into an arbitrarily designated number of map sheets.

In the present embodiment, the user may handwrite some information on the map printed by the MFP 18, and register the information relating to, e.g. a road or a shop in the map information service providing server 14. For example, assume now that the user moves while viewing the printed map and has handwritten on the map a line along the road that is a route of movement. In FIG. 7, the handwritten line representing the route of movement is indicated by L1. In addition, assume that the user has written on the map a line encircling the location of the shop at which the user stopped in while moving. In FIG. 7, the line encircling the location of the shop is indicated by L2.

In the scan process which will be described later, as illustrated in FIG. 8, the information of lines L1 and L2, which are recorded on the map by the user, is extracted as differential images, and the information, which is to be registered in the map information service providing server 14, is determined, based on the information of lines L1 and L2 recorded on the map by the user.

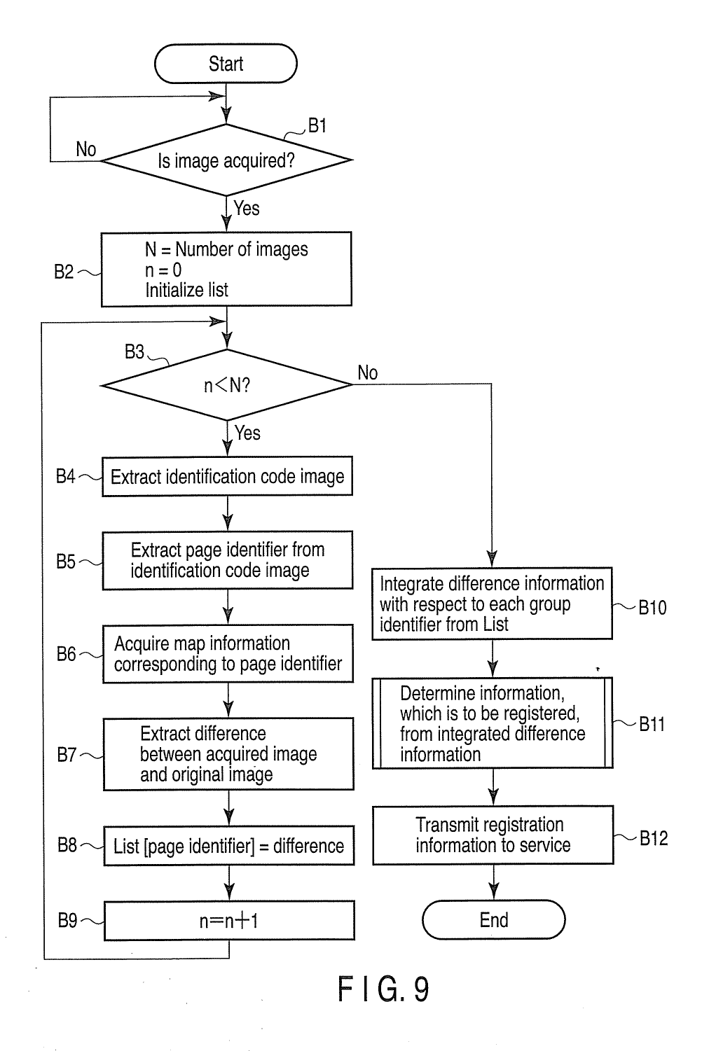

Next, referring to a flow chart of FIG. 9, a description is given of the scan process of the map information registration module 10b in the map information processing apparatus 10. The scan process is a process for reading, by the MFP 18, the information which has been written by the user on the map printed by the MFP 18, and registering the read information in the map information service providing server 14.

If the map that is a target of scan (image read) is set and the execution of scan for information registration is instructed, the image read unit 43 of the MFP 18 scans (image-reads) the set map by the scanner function. When a plurality of maps are set, the images of all maps are scanned.

If the QR codes 71a to 79a, which are combined with the maps 71 to 79, include information which makes it possible to determine which maps correspond to which positions of the whole map that has been designated by the user as the target of print, the order in which the maps are set on the MFP 18 may not be a predetermined order. Specifically, based on the information obtained from the QR codes 71a to 79a, the information read from the respective maps can be rearranged. Even if the QR codes 71a to 79a do not include the information indicative of the positions in the whole map, the information that is read from each map can be processed in the correct order by executing the scan of the maps 71 to 79 by arranging the maps 71 to 79 in a predetermined order.

If the image scan of all maps by the image read unit 43 is completed, the image transmission unit 44 transmits the images to the image acquisition unit 30 of the map information processing apparatus 10.

In this case, the MFP 18 (image transmission unit 44) may designate the folder in the map information processing apparatus 10 and transmit the images to the designated folder. The map information processing apparatus 10 monitors at regular intervals the folder designated by the MFP 18, and detects the reception of new images from the MFP 18. Alternatively, the transmission of images may be executed by making use of a Web service such as Device Profile for Services (DPWS).

If the image acquisition unit 30 of the map information processing apparatus 10 receives images from the MFP 18 (image transmission unit 44) (Yes in Act B1), the image acquisition unit 30 sets, as initial setup for processing a plurality of images, the number of images received from the MFP 18 to “N”, sets the “n” indicative of the image, which is the target of processing, to “0”, and initializes the list (List) which manages the image that is the target of processing (Act B2).

The page/group identifier extraction unit 31 specifies a region of an identification code image such as a QR code, from an n-th (default: 0) image which has been received by the image acquisition unit 30, and extracts the page identifier and group identifier from the identification code image in the specified region (Act B4). If the position of the identification code image is determined, for example, like the QR code 56 in FIG. 5, the page/group identifier extraction unit 31 enhances the efficiency of the process by specifying the identification code image, while setting the predetermined position in the image (the vicinity of the corner of the image in FIG. 5) to be the target of scan.

In the meantime, the specifying of the identification code image can be executed by making use of other image processing techniques such as a contour line extraction process.

Next, the image difference extraction unit 32 acquires the print map information which is stored in the print map information storage table shown in FIG. 6, by using as keys the group identifier and page identifier extracted by the page/group identifier extraction unit (Act B6). Specifically, the image difference extraction unit 32 searches for the information which agrees with the group identifier and the page identifier, and reads out the print image (map image) from the destination of recording which is indicated by the image path associated with the corresponding page identifier.

Subsequently, the image difference extraction unit 32 extracts a difference between the image acquired in the image acquisition unit 30 and the original image which is read from the image path of the print map information (Act B7), and temporarily stores the group identifier and page identifier, which indicate the image that is the target of processing, and a differential image, which has been extracted by the difference, as difference information in the list (Act B8). Since the original image, which is recorded at the location indicated by the image path, is the map that is printed on the map read by the MFP 18, the common part of the map is erased by extracting the difference between the images, and a differential image of the part that was written on the map by the user, as shown in FIG. 8, is extracted. Although the identification code image, which is combined with the map, is not erased by the difference between the images, the identification code image is ignored since this is a small range in the whole image.

In the case where there are a plurality of images acquired from the MFP 18, the image difference extraction unit 32 repeatedly extracts the group identifier and page identifier of each image and extracts a differential image, as described above (Act B4 to B9), while updating (incrementing) the “n” indicative of the image that is the target of processing (Act B9), until the value “n” reaches N that is the total number of images (Act B3).

Next, the registration information determination unit 33 integrates the differential images with respect to each of the group identifiers, based on the group identifiers and page identifiers which are temporarily stored in the list (Act B10). Specifically, as shown in FIG. 8, the respective differential images are rearranged and combined, based on the page identifiers, according to the arrangement of the respective differential images in the whole map.

In addition, the registration information determination unit 33 reads out the information (latitude, longitude, reduction scale) indicating the map corresponding to the page identifier which is recorded on the print map information storage table, and requests, based on this information, map information from the map information service providing server 14. Then, the registration information determination unit 33 determines the information which is to be registered in the map information service providing server 14, based on the map information received from the map information service providing server 14 and the differential image corresponding to this map information (Act B11).

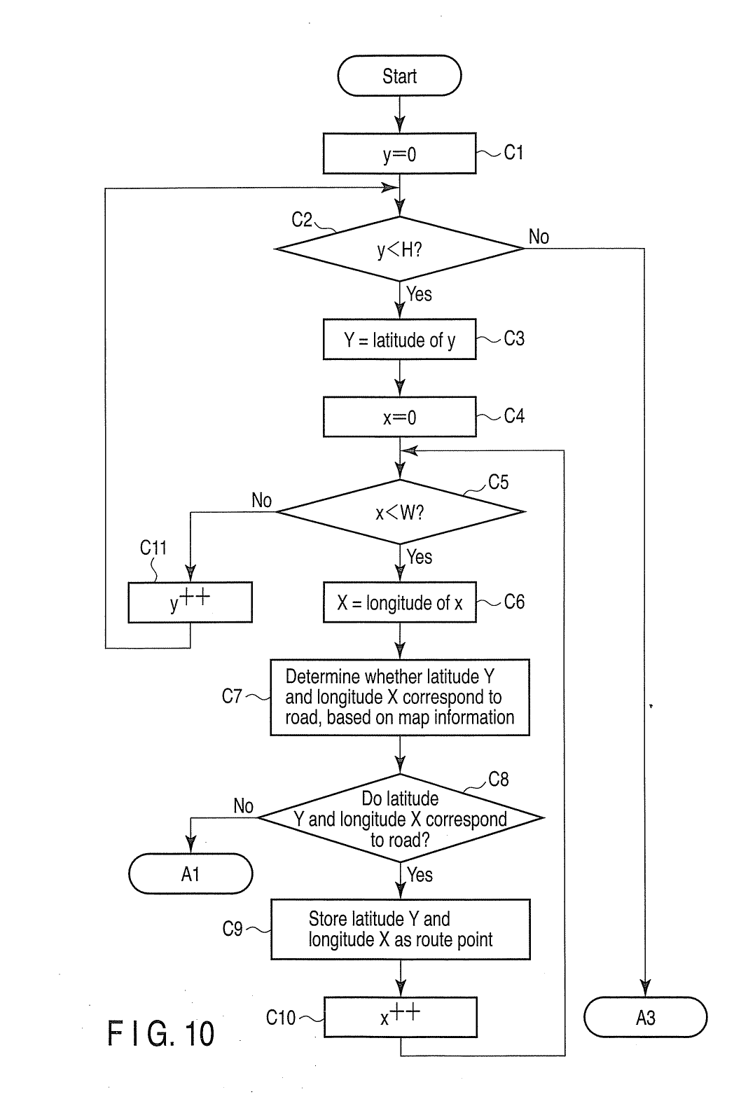

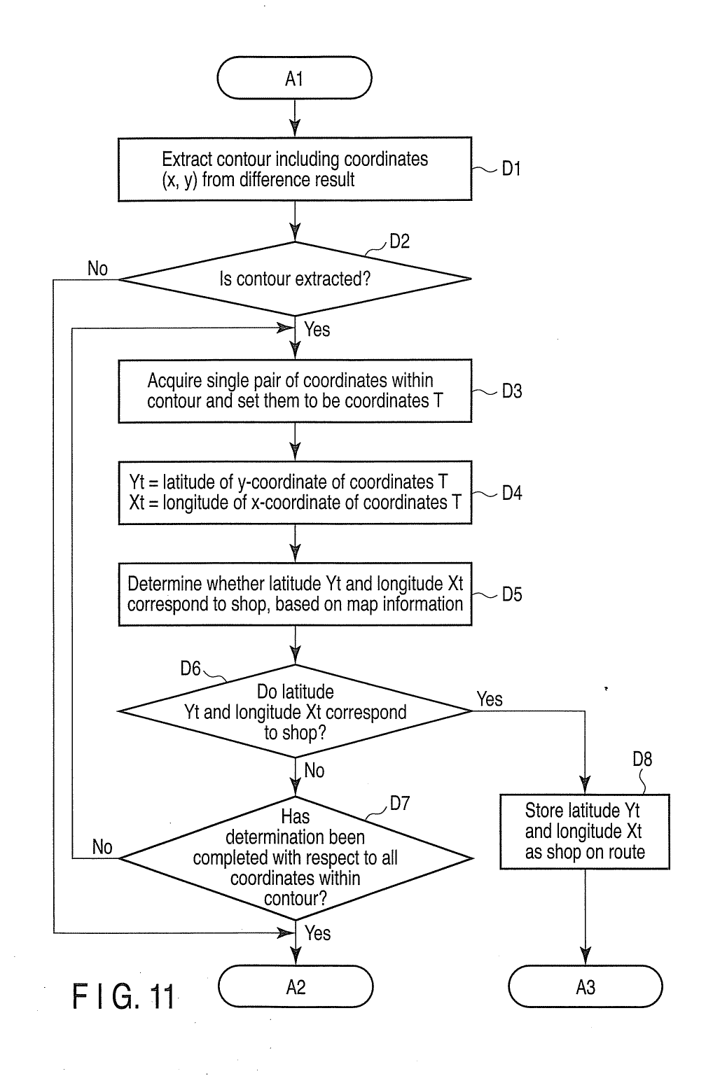

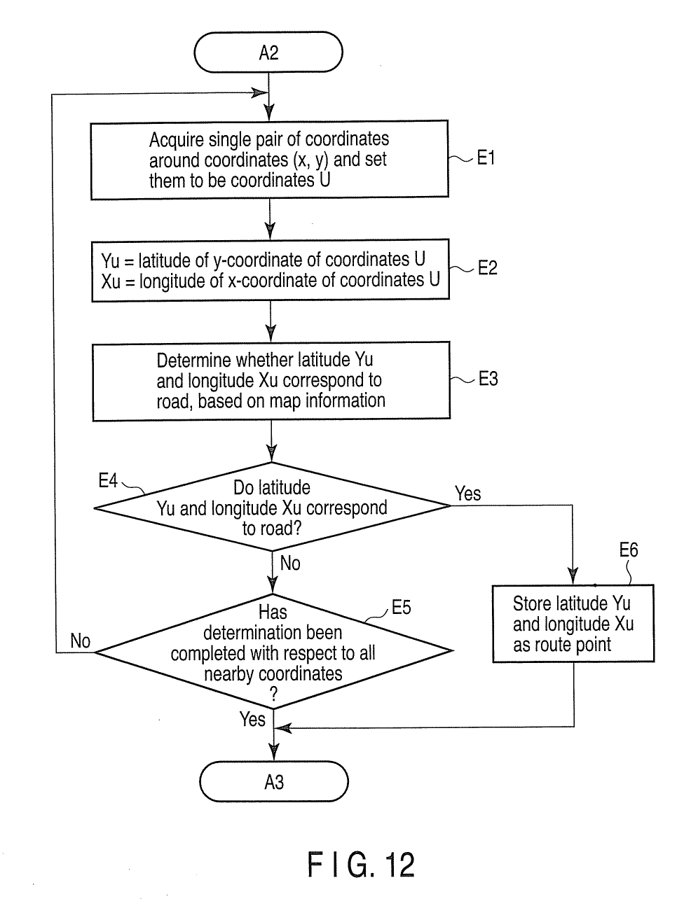

Next, referring to flow charts of FIG. 10, FIG. 11 and FIG. 12, a description is given of an example of a determination method of determining information that is to be registered in the map information service providing server 14 by the registration information determination unit 33.

The case is now described, by way of example, in which lines (lines L1 and L2), which were written by the user on the map that is printed in divisions with three map sheets in the vertical direction and three map sheets in the horizontal direction, as shown in FIG. 7, are extracted as shown in FIG. 8. It is assumed that the information, which is to be registered in the map information service providing server 14, includes, for example, information on a road (route) and information on a shop, which are indicated on the map by handwriting by the user.

As regards each data of the differential image, it is assumed that an x-coordinate (abscissa) and a y-coordinate (ordinate) of xy-coordinates having the uppermost leftmost point of the differential image as the origin, and difference data corresponding to a line part, which is handwritten by the user (“1” at a position where there is a difference, “0” at a position where there is no difference), are managed as one data.

In the flow chart of FIG. 10, all data of the differential image are successively processed. It is determined whether data of difference data “1” (a part handwritten by the user) corresponds to a road on the map. If the data corresponds to the road, the data is stored as a route point.

The y-coordinate and x-coordinate are set at initial values “0” (Act C1, Act C4). The latitude of the y-coordinate on the map is set at Y (Act C3), the longitude of the x-coordinate on the map is set at X (Act C6), and the x-coordinate is successively incremented (Act 010). It is determined whether the difference data corresponding to the current coordinate (x, y) is “1” and the position at the latitude Y and longitude X corresponds to the road, based on the information relating to the road included in the map information which is received from the map information service providing server 14 (Act C7).

If it is determined that the position at the latitude Y and longitude X corresponds to the road (Yes in Act C8), the registration information determination unit 33 stores the latitude Y and longitude X as a route point which was handwritten on the map by the user (Act C9). Specifically, the latitude Y and longitude X of the part corresponding to the line L1 in FIG. 8 are stored as the information representing the route.

The registration information determination unit 33 executes the above-described determination (Act C7) by successively incrementing the x-coordinate until the x-coordinate becomes equal to the number of pixels, W, in the horizontal direction (x-coordinate) of the differential image (Act C5, Act C10). If the x-coordinate is incremented up to the number of pixels, W (No in Act C5), the y-coordinate is incremented (Act C11) and the above-described process is repeatedly executed (Act C2 to Act C10). If the registration information determination unit 33 completes the process until the y-coordinate becomes equal to the number of pixels, H, in the vertical direction (y-coordinate) of the differential image (No in Act C2), the registration information determination unit 33 determines that the determination for all pixels of the difference image has been completed, and finishes the process.

On the other hand, if it is determined that the position at the latitude Y and longitude X does not corresponds to the road (No in Act C8), the registration information determination unit 33 extracts from the differential image a predetermined contour line (part of difference data “1”) including the coordinates (x, y) which are the target of the present processing (FIG. 11, Act D1). Specifically, as regards the part which includes the coordinates (x, y) of the difference data “1” and does not correspond to the road, it is determined whether this part is a part which was input by handwriting by the user in order to register the information relating to a shop. In this case, it is assumed that the contour line is, for example, a line surrounding the position of the shop, which is input by handwriting by the user when the position of the shop is designated.

When the contour line including the coordinates (x, y) has been extracted (Yes in Act D2), the registration information determination unit 33 acquires a single pair of coordinates within the contour and sets the coordinates to be coordinates T (Act D3), and also sets the latitude of the y-coordinate of the coordinates T to be Yt and sets the longitude of the x-coordinate of the coordinates T to be Xt (Act D4).

The registration information determination unit 33 determines whether there is a shop at the position corresponding to the latitude Yt and longitude Xt, based on the information relating to shops included in the map information which has been received from the map information service providing server 14 (Act D5).

If it is determined that there is no shop at the position corresponding to the latitude Yt and longitude Xt (No in Act D6) and if the above-described determination has not been completed with respect to all coordinates within the contour (No in Act D7), the registration information determination unit 33 increments the coordinate value and acquires other coordinates, thereby repeatedly executing the same process as described above (Act D3 to Act D6).

On the other hand, if it is determined that there is a shop at the position corresponding to the latitude Yt and longitude Xt (Yes in Act D6), the registration information determination unit 33 stores the latitude Yt and longitude Xt as the shop (e.g. the shop at which the user stopped in while moving) which as designated by a handwritten surrounding line on the map by the user (Act D8). In addition, as well as the latitude Yt and longitude Xt, the information relating to the shop itself (e.g. the name of the shop, the address, the telephone number, etc.) which is included in the map information may be stored.

When the contour line (part of difference data “1”) including the coordinates (x, y) that are the target of the present processing has not been extracted (No in Act D2), that is, when neither a route point nor a shop on a route is determined at the part of the difference data “1” of the difference image, the registration information determination unit 33 corrects the position that is the target of determination, and executes the determination of a route point. Specifically, when the user handwrites a line on the map in order to indicate a route, it would be possible that the line could not be exactly written along the road. Even in this case, if there is a road near the handwritten line, the part of the handwritten line is stored as a route point.

The registration information determination unit 33 acquires a pair of coordinates (e.g. one of eight pairs of nearby coordinates) near the coordinates (x, y), which are the target of the present processing, from the differential image, and sets the acquired coordinates to be coordinates U (FIG. 12, Act E1), and also sets the latitude of the y-coordinate of the coordinates U to be Yu and the longitude of the x-coordinate of the coordinates U to be Xu (Act E2).

The registration information determination unit 33 determines whether the position at the latitude Yu and longitude Xu corresponds to a road, based on the information relating to roads included in the map information which has been received from the map information service providing server 14 (Act E3).

If it is determined that the position at the latitude Yu and longitude Xu corresponds to a road (Yes in Act E4), the registration information determination unit 33 stores the latitude Yu and longitude Xu as a route point on the route which was handwritten on the map by the user (Act E6). Specifically, even if the part of the road was not exactly handwritten on the map, the part of the road can be stored as information representing the route.

On the other hand, if it is determined that the position at the latitude Yu and longitude Xu does not corresponds to a road (No in Act E4) and if the determination has not been completed with respect to all coordinates around the coordinates (x, y) that are the target of the present processing (No in Act E5), the registration information determination unit 33 acquires another pair of coordinates around the coordinates (x, y) and repeatedly executes the same process as described above (Act E1 to Act E5). The range of coordinates around the coordinates (x, y) that are the target of processing can be determined in accordance with the range of tolerance of the error between the handwritten line and the road.

In this manner, the registration information determination unit 33 can determine the information which is to be registered in the map information service providing server 14, based on the differential image and the map information acquired from the map information service providing server 14.

The above-described registration of the information relating to the road (route) and the shop is merely an example. Any information, which can be discriminated based on the differential image and the map information, can be registered in the map information service providing server 14 by presetting rules (determination methods) with respect to each target information. For example, in the above description, the surrounding line is used only in the case of designating the shop (a specific object on the map). However, the shop may be designated by other forms such as dots or specific symbols.

A pattern (differential image) itself, such as a character or a figure handwritten by the user, may be used as information that is the target of registration. Thereby, a memo, a figure or an illustration, which is handwritten on the map by the user, for instance, can be set to be the target of registration. In addition, handwritten characters can be converted to character codes by a character recognition process and can be set to be the target of registration.

In this manner, if the information which is to be registered in the map information service providing server 14 is stored by the registration information determination unit 33, the information registration unit 34 registers the information of the route or the shop at which the user stopped in, which was designated on the map by handwriting by the user, by using the Web service provided by the map information service providing server 14 (FIG. 9, Act B12).

The map information service providing server 14 records the information registered from the map information processing apparatus 10 by the Web service, and makes the registered information open to the public via the Web (Internet 12).

As has been described above, by making use of the map information processing system of the embodiment, it is possible to print the map, which has been designated by the user via the Web browser 40 of the MFP 18, by dividing the map into a designated number of map sheets. In addition, by scanning the map by the MFP 18, the information written on the map can easily be registered on the Web service of the map information service providing server 14 via the map information processing apparatus 10. Therefore, it is possible to reduce the cost of printing the map on a plurality of paper sheets, and the cost due to digitalization, such as the cost of registering on the Web service the information written on the map printed on plural sheets.

In the above description, the map information processing apparatus 10 is configured as an independent apparatus. Alternatively, the function of the map information processing apparatus 10 may be implemented in the MFP 18. In this case, the MFP 18, in which the function of the map information processing apparatus 10 is implemented, is connected to the map information service providing server 14 via the LAN 16 and Internet 12. The MFP 18 can acquire necessary information from the map information service providing server 14, and can register information designated by the user in the map information service providing server 14. In this case, the MFP 18, in which the function of the map information processing apparatus 10 is implemented, can provide other ordinary MFPs 18 with the same process as the above-described process of the map information processing apparatus 10. Thus, by equipping the map information processing system with the MFP 18 in which the function of the single map information processing apparatus 10 is implemented, it becomes possible to easily register information in the map information service providing server 14 from other MFPs 18 having ordinary functions.

In the above description, the information designated by the user is registered in the map information service providing server 14 via the map information processing apparatus 10. Alternatively, the information may be transmitted via the Internet 12 and registered in a registration server which is provided independently from the map information service providing server 14, or in a personal computer which is individually used.

Although print is executed by designating the map via the EWB (Web browser 40) of the MFP 18, a print instruction may be sent to the map information processing apparatus 10 by accessing the map information processing apparatus 10 from a PC (Personal Computer) including a browser.

Furthermore, in the above description, the map information processing program is pre-recorded in the map information processing apparatus 10. Alternatively, the map information processing program may be downloaded from, e.g. some other server via the Internet 12, or the map information processing program may be installed from a recording medium in which the map information processing program is recorded. As the recording medium, for example, CD-ROM may be used to store the program. The type of the recording medium is not limited, if the recording medium can store the program and the recording medium can be read by the apparatus. The function, which is obtained by preinstall or download, may be realized in cooperation with, e.g. the OS in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A map information processing apparatus comprising:
a generation unit configured to generate a print image for printing a map designated by a user;
a transmitter configured to transmit to a print device the print image generated by the generation unit;
a receiver configured to receive an image transmitted from the print device;
an extraction unit configured to extract a differential image by extracting a difference between the image received by the receiver and the print image;
a determination unit configured to determine registration information which is a target of registration, based on the differential image and the map corresponding to the print image; and
a registration unit configured to register the registration information, which is determined by the determination unit, in an information registration device.

2. The map information processing apparatus of claim 1, wherein the generation unit is configured to generate a plurality of print images when a plural number of prints is designated by the user, and
the extraction unit is configured to extract, when a plurality of images are received by the receiver, the differential image by extracting differences between the plurality of images and the plurality of print images.

3. The map information processing apparatus of claim 2, further comprising:
an identifier generation unit configured to generate identifiers indicating a relationship between the plurality of print images;
an identification code generation unit configured to generate identification code images corresponding to the identifiers;
a combining unit configured to combine the identification code images with the plurality of print images; and
an identifier extraction unit configured to extract the identifiers, based on the identification code images combined with the images received by the receiver,
wherein the extraction unit is configured to combine the plurality of images in accordance with the relationship indicated by the identifiers extracted by the identifier extraction unit, and to extract a differential image between the combined images and the plurality of print images.

4. The map information processing apparatus of claim 1, wherein the determination unit is configured to determine, when the differential image agrees with a position of an object printed on the map, information relating to the object to be the target of registration.

5. The map information processing apparatus of claim 1, wherein the determination unit is configured to determine, when the differential image agrees with a position near an object printed on the map, information relating to the object to be the target of registration.

6. A map information processing apparatus comprising:
a generation unit configured to generate a print image for printing a map designated by a user;
a printer configured to print the print image generated by the generation unit;
a scanner configured to scan a print printed by the printer, and to input an image thereof;
an extraction unit configured to extract a differential image by extracting a difference between the image input by the scanner and the print image;
a determination unit configured to determine registration information which is a target of registration, based on the differential image and a map corresponding to the print image; and
a registration unit configured to register the registration information, which is determined by the determination unit, in an information registration device.

7. A map information processing method comprising:
generating a print image for printing a map designated by a user;
transmitting the print image to a print device;
receiving an image transmitted from the print device;
extracting a differential image by extracting a difference between the image and the print image;
determining registration information which is a target of registration, based on the differential image and a map corresponding to the print image; and
registering the registration information in an recording device.

8. The map information processing method of claim 7, wherein the generating includes generating a plurality of print images when a plural number of prints is designated by the user, and
the extracting includes extracting, when a plurality of images which are transmitted from the print device are received, the differential image by extracting differences between the plurality of images and the plurality of print images.

9. The map information processing method of claim 8, further comprising:
generating identifiers indicating a relationship between the plurality of print images;
generating identification code images corresponding to the identifiers;
combining the identification code images with the plurality of print images; and
extracting the identifiers, based on the identification code images combined with the images received from the print device,
wherein the plurality of images are combined in accordance with the relationship indicated by the extracted identifiers, and a differential image between the combined images and the plurality of print images is extracted.

10. The map information processing method of claim 7, wherein when the differential image agrees with a position of an object printed on the map, information relating to the object is determined to be the target of registration.

11. The map information processing method of claim 7, wherein when the differential image agrees with a position near an object printed on the map, information relating to the object is determined to be the target of registration.

12. A non-transitory computer readable medium having stored thereon a computer program which is executable by a computer, the computer program controlling the computer to execute functions of:
generating a print image for printing a map designated by a user;
transmitting the print image to a print device;
receiving an image transmitted from the print device;
extracting a differential image by extracting a difference between the image and the print image;
determining registration information which is a target of registration, based on the differential image and a map corresponding to the print image; and
registering the registration information in an information recording device.
